(19) United States
(12) Patent Application Publication
(10) Pub. No.: US 2026/0143515 A1
(43) Pub. Date: May 21, 2026

(54) RAN INTELLIGENT CONTROLLER, DYNAMIC RESOURCE BLOCK CONFIGURATION METHOD AND BASE STATION WITH DYNAMIC RESOURCE BLOCK CONFIGURATION

(71) Applicant: Industrial Technology Research Institute, Hsinchu (TW)

(72) Inventors: Tzu-Lin Wang, New Taipei City (TW); Chai-Hien Gan, Hsinchu City (TW); Wan-Yi Lin, Hsinchu City (TW); Kai-Wen Chen, Tainan City (TW)

(73) Assignee: Industrial Technology Research Institute, Hsinchu (TW)

(21) Appl. No.: 18/954,563

(22) Filed: Nov. 21, 2024

(51) Int. Cl. H04W 72/541; H04W 24/08; H04W 72/53

(52) U.S. Cl. CPC H04W 72/541; H04W 24/08; H04W 72/53

(57) ABSTRACT

A Radio Access Network Intelligent Controller (RIC), a dynamic Resource Block (RB) allocation method, and a related base station. The dynamic RB configuration method include the followings. The RIC obtains network status information from multiple BSs. Based on the network status information, the RIC identifies at least one first UE among multiple UEs that is experiencing interference. The RIC sets multiple dynamic RB allocation strategies corresponding to multiple BSs based on the network status information, at least one first UE, and at least one first BS. The RIC transmits the multiple dynamic RB allocation strategies to corresponding to ones of the multiple BSs. In response to a dynamic adjustment condition being triggered, the RIC re-obtain the network status information, to update the multiple dynamic RB allocation strategies, and transmit the multiple updated dynamic RB allocation strategies to corresponding ones of the multiple BSs.

### BACKGROUND

### Technical Field

This disclosure relates to wireless communication technology field, particularly to a dynamic resource block configuration method, and a radio access network (RAN) intelligent controller (RIC) using said method and a base station (BS) benefiting from said method.

### Description of Related Art

With the widespread deployment of 5G networks, network density continues to increase, making inter-cell interference management an important issue. This has also led to dynamic resource allocation becoming one of the key technologies for improving network performance. As network complexity increases, researchers are exploring more intelligent and adaptive resource management methods. The introduction of O-RAN (Open Radio Access Network) architecture provides new possibilities for this.

### SUMMARY

One or more embodiments of the present disclosure provide a Radio Access Network (RAN) Intelligent Controller (RIC), adapted for a wireless communication system, the RIC comprising: a communication circuit unit, wherein the RIC is communicatively connected to a plurality of Base Stations (BSs) of the wireless communication system through the communication circuit unit, wherein the plurality of BSs are communicatively connected to a plurality of UEs; and a processor. The processor is configured by executing a plurality of program modules to: obtain a plurality of network status information corresponding to the plurality of UEs from the plurality of BSs; identify at least one first UE being interfered among the plurality of UEs based on the plurality of network status information; set a plurality of dynamic Resource Block (RB) allocation strategies corresponding to the plurality of BSs based on the plurality of network status information, the at least one first UE, and at least one first BS, so as to divide a plurality of RBs that can be allocated by each BS into a plurality of first RB groups and a second RB group, wherein the plurality of dynamic RB allocation strategies indicate that: a plurality of first RBs in the plurality of first RB groups is used to provide for the at least one first UE, and a plurality of second RBs in the second RB group is used to provide for a second UE other than the at least one first UE among the plurality of UEs; transmit the plurality of dynamic RB allocation strategies to corresponding ones of the plurality of BSs; and in response to a dynamic adjustment condition being triggered, re-obtain the network status information to update the plurality of dynamic RB allocation strategies, and transmit the plurality of updated dynamic RB allocation strategies to corresponding ones of the plurality of BSs.

One or more embodiments of the present disclosure provide a dynamic Resource Block configuration method, adapted for a Radio Access Network (RAN) Intelligent Controller (RIC) of a wireless communication system, wherein the RIC is communicatively connected to a plurality of Base Stations (BSs) of the wireless communication system, wherein the plurality of BSs are communicatively connected to a plurality of UEs. The method includes: obtaining a plurality of network status information corresponding to the plurality of UEs from the plurality of BSs; identifying at least one first UE being interfered among the plurality of UEs based on the plurality of network status information; setting a plurality of dynamic Resource Block (RB) allocation strategies corresponding to the plurality of BSs based on the plurality of network status information, the at least one first UE, and at least one first BS, so as to divide a plurality of RBs that can be allocated by each BS into a plurality of first RB groups and a second RB group, wherein the plurality of dynamic RB allocation strategies indicate that: a plurality of first RBs in the plurality of first RB groups is used to provide for the at least one first UE, and a plurality of second RBs in the second RB group is used to provide for a second UE other than the at least one first UE among the plurality of UEs; transmitting the plurality of dynamic RB allocation strategies to corresponding ones of the plurality of BSs; and in response to a dynamic adjustment condition being triggered, re-obtaining the network status information to update the plurality of dynamic RB allocation strategies, and transmitting the plurality of updated dynamic RB allocation strategies to corresponding ones of the plurality of BSs.

One or more embodiments of the present disclosure provide a Base Station with dynamic Resource Block configuration, adapted for a wireless communication system, the Base Station comprising: a communication circuit unit, wherein the Base Station is communicatively connected to a Radio Access Network (RAN) Intelligent Controller (RIC) of the wireless communication system through the communication circuit unit, wherein the Base Station is communicatively connected to a plurality of UEs through the communication circuit unit; and a processor. The processor is configured by executing a plurality of program modules to: continuously receive a plurality of network status information from associated ones of the plurality of UEs, and transmit the received plurality of network status information to the RIC; in response to receiving a dynamic Resource Block (RB) allocation strategy from the RIC, divide a plurality of RBs that can be allocated by the Base Station into a plurality of first RB groups and a second RB group according to the dynamic RB allocation strategy, and identify a target first RB group being set to the Base Station among the plurality of first RB groups; identify at least one first UE being allocated to the target first RB group and at least one second UE being allocated to the second RB group among the plurality of UEs according to the dynamic RB allocation strategy; generate transmission resource allocation information corresponding to the plurality of UEs according to the target first RB group and the second RB group; and transmit the transmission resource allocation information to the plurality of UEs to enable the plurality of UEs to identify respective allocated RBs according to the received transmission resource allocation information and perform uplink or downlink transmission through the allocated RBs.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a wireless communication system according to an embodiment of the present disclosure.

FIG. 2A is a block diagram of a Radio Access Network Intelligent Controller according to an embodiment of the present disclosure.

FIG. 2B is a block diagram of a base station according to an embodiment of the present disclosure.

FIG. 3 is a flowchart of a dynamic Resource Block configuration method used by a Radio Access Network Intelligent Controller according to an embodiment of the present disclosure.

FIG. 4 is a flowchart of base station operation according to an embodiment of the present disclosure.

FIG. 5 is a sequence diagram of wireless communication system according to an embodiment of the present disclosure.

FIG. 6 is a diagram illustrating multiple UEs within coverage areas of multiple base stations and corresponding RSRP differences according to an embodiment of the present disclosure.

FIG. 7 is a diagram illustrating the relationship graph determined according to coverage areas and overlapping relationships of multiple base stations and setting corresponding dynamic RB configuration strategies according to an embodiment of the present disclosure.

FIG. 8 is a diagram illustrating setting dynamic RB configuration strategies to allocate different RB groups to multiple UEs according to interference conditions of multiple UEs according to an embodiment of the present disclosure.

FIG. 9 is a diagram illustrating allocating different UEs to corresponding RB groups according to received dynamic RB configuration strategies according to an embodiment of the present disclosure.

FIG. 10 is a diagram illustrating experimental results of applying this method according to an embodiment of the present disclosure.

### DESCRIPTION OF THE EMBODIMENTS

Now detailed reference will be made to preferred embodiments of the disclosure/present disclosure, examples of which are illustrated in the accompanying drawings. Reference numerals refer to the same or similar elements are used as much as possible throughout the drawings and description.

It should be understood that the terms “system” and “network” are often used interchangeably in the present disclosure. The term “and/or” in the present disclosure is only used to describe association relationships between associated objects, which means that three relationships may exist. For example, A and/or B may mean three situations: A alone exists, A and B exist simultaneously, or B alone exists. Additionally, the character “/” in the present disclosure generally indicates that the associated objects are in an “or” relationship.

The Radio Access Network (RAN) Intelligent Controller (RIC) is a key component proposed by the O-RAN Alliance, which aims to provide more intelligent and flexible control capabilities for 5G and future wireless networks. The RIC can be divided into: Non-RT RIC (non-real-time RIC): located at the top layer, responsible for non-real-time control and management functions; and Near-Time RIC (near-real-time RIC): located at the middle layer, responsible for near-real-time network control and optimization functions. An A1 interface is used to connect between the non-real-time RIC and near-real-time RIC. The near-real-time RIC can connect to associated multiple E2 nodes (e.g., base stations) through an E2 interface.

A1 interface: connects non-real-time RIC and near-real-time RIC, used for transmitting non-real-time policies and control instructions. E2 interface: connects near-real-time RIC and E2 node, used for near-real-time control and data collection.

In the present embodiment, the near-real-time RIC is used as the main control device to respond to network conditions in real-time or near-real-time. Moreover, the RIC also needs to handle tasks such as processing UE Measurement Reports (MR), calculating interference maps, and formulating RB allocation strategies. These tasks require faster response times and fall within the responsibilities of the near-real-time RIC. On the other hand, the RIC provided by the present disclosure is directly connected to E2 nodes (representing base stations) through the E2 interface, which enables the near-real-time RIC to quickly obtain network status and issue control instructions. Furthermore, since the present disclosure also performs operations such as dynamic adjustment of RB allocation based on real-time network conditions, calculation of RSRP differences, establishment of interference maps (or relationship graphs), generation/setting of dynamic RB configuration strategies, all of which require the near-real-time RIC's capability to process large amounts of real-time data.

However, in one embodiment, the RIC may also represent an electronic device or server that integrates non-real-time RIC and near-real-time RIC together.

One or more embodiments of the present disclosure provide a dynamic Resource Block allocation method based on O-RAN architecture and a Radio Access Network Intelligent Controller (RAN Intelligent Controller, RIC), Base Station (BS) and related system for resource management in 5G networks. The method includes: User Equipment (UE) measures and reports Reference Signal Received Power (RSRP) values; base station transmits UE measurement reports and Key Performance Measurement (KPM) information to RIC through O-RAN standard interface; RIC analyzes data, determines interference conditions between multiple UEs and multiple BSs, and formulates dynamic Resource Block (RB) allocation strategies; RIC distributes strategies to base stations for execution. One or more embodiments of the present disclosure effectively reduce interference between base stations while improving spectrum utilization by dividing spectrum into interference areas and non-interference areas, and dynamically adjusting their ratio according to network load.

The radio access network intelligent controller (RAN Intelligent Controller, RIC), dynamic Resource Block configuration method and base station with dynamic Resource Block configuration provided by one or more embodiments of the present disclosure can effectively solve interference problems and low spectrum utilization problems existing in current technology. The present disclosure obtains network status information corresponding to multiple User Equipment (UE) from multiple base stations (BS) through RIC, identifies interfered UEs, and sets dynamic Resource Block (RB) allocation strategies to divide each BS's allocatable RBs into multiple first RB groups and one second RB group. Among them, first RB group is used for interfered UEs, second RB group is used for other UEs. RIC transmits these strategies to corresponding BSs and can update strategies based on dynamic adjustment conditions. This method not only effectively reduces interference and improves spectrum utilization, but also has high flexibility and scalability, able to adjust resource allocation in real-time according to changes in network environment. Therefore, the present disclosure provides an innovative and efficient solution for 5G network resource management.

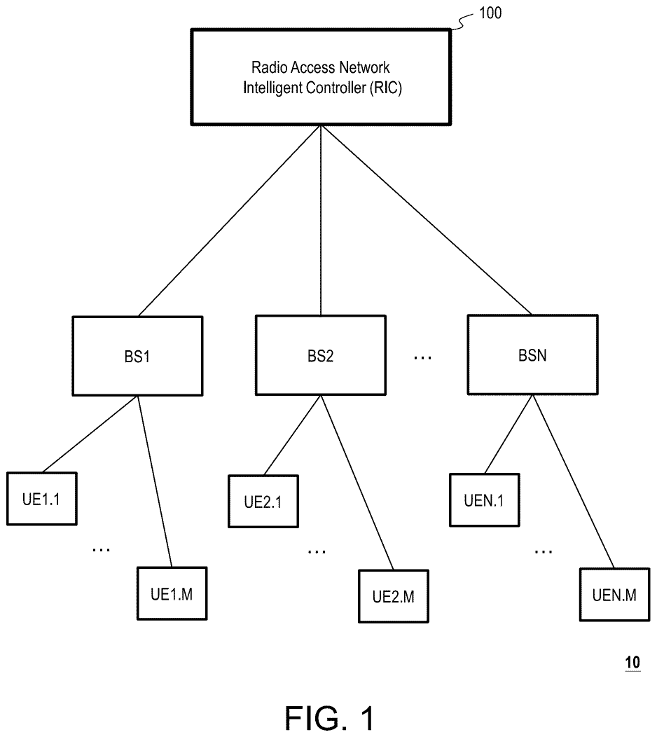

FIG. 1 is a block diagram of a wireless communication system according to an embodiment of the present disclosure. In one embodiment, as shown in FIG. 1, the wireless communication system 10 includes a Radio Access Network Intelligent Controller (RAN Intelligent Controller, RIC) 100, multiple base stations BS1, BS2, . . . , BSN, and multiple user equipment UE1.1 to UE1.M, UE2.1 to UE2.M, . . . , UEN.1 to UEN.M connected to multiple base stations BS1, BS2, . . . , BSN respectively. For example, the serving base station for UE1.1˜UE1.M is base station BS1.

RIC 100 is communicatively connected to multiple base stations BS1 to BSN through a communication circuit unit. Each base station establishes communication connections with multiple UEs within its coverage area. For example, BS1 connects to UE1.1 to UE1.M, BS2 connects to UE2.1 to UE2.M, and so on until BSN connects to UEN.1 to UEN.M.

In one embodiment, the wireless communication system 10 provided by the present disclosure implements a dynamic resource block allocation method based on O-RAN architecture. For example, in one embodiment, UE measures RSRP values and reports back to the base station through MR (Measurement Report), the base station periodically reports its monitored information (RSRP, RSRQ, SINR) to RIC through O-RAN standard interface (such as E2, or M-plane, etc.) with KPM (SS-SINR/SS-RSRP/SS-RSRQ); RIC calculates interference levels using RSRP differences, and RIC calculates interference maps and RB dynamic allocation strategies. Finally, RIC sends RB dynamic allocation decisions to base stations through O-RAN standard interface.

More specifically, the dynamic resource block allocation method based on O-RAN architecture includes the following steps:

User Equipment (UE) measuring and reporting: (a) UE continuously measures RSRP values of surrounding base stations; (b) UE reports RSRP values to serving base station through Measurement Report (MR).

Base station information collection and transmission: (a) base station receives measurement reports from UE; (b) base station transmits UE's measurement reports and its own Key Performance Measurement (KPM, including SS-SINR/SS-RSRP/SS-RSRQ) information to RIC through O-RAN standard interface.

RIC analysis and strategy formulation: (a) RIC receives information from multiple base stations; (b) RIC calculates interference levels using RSRP differences, the formula for RSRP difference is: |(RSRP between UE and serving base station)−(RSRP between UE and neighboring base station)|, wherein the interference level can be determined based on whether it is less than a preset threshold (e.g., 12 dBm); (c) RIC identifies UEs (interfered UEs) that need special handling based on calculation results; (d) RIC formulates dynamic Resource Block (RB) allocation strategies based on the configuration status of all base stations'signal coverage areas and UEs'interference levels, dividing each BS's allocatable RBs into multiple interference areas and non-interference areas, so as to allocate interfered UEs to corresponding interference areas.

Dynamic RB allocation: (a) RIC dynamically adjusts the ratio between interference areas and non-interference areas based on network load conditions; (b) RIC uses complete graph concepts for RB allocation of neighboring base stations to ensure interference area RBs do not overlap.

Strategy distribution and execution: (a) RIC distributes RB dynamic allocation decisions to each base station through O-RAN standard interface; (b) base stations allocate appropriate RBs to their subordinate UEs according to received strategies.

Periodic updates: The entire process is periodically repeated to adapt to dynamic changes in the network environment.

Fine-grained RB allocation strategy: RIC provides detailed RB allocation instructions for each base station, including: (a) starting position and width of RBs in interference areas (ICI) and non-interference areas (UI); (b) specific RB allocation for each UE in interference areas or non-interference areas.

Through this method, RIC 100 can dynamically adjust resource allocation based on real-time network conditions, effectively reducing interference in the network and improving overall network performance. Meanwhile, since RIC adopts a centralized management approach, it can optimize resource allocation from a global perspective, avoiding the local optimization problems that might arise from relying solely on individual base station decisions.

Furthermore, this structural design fully utilizes the advantages of O-RAN, implementing efficient communication between RIC and base stations through O-RAN standard interfaces, making the entire system highly scalable and flexible, enabling RIC 100 to effectively manage and control the entire network, while base station BS1 can flexibly execute strategies issued by RIC and directly communicate with UEs. This layered architecture ensures both overall network optimization and local autonomy of each base station.

O-RAN standard interface, in one embodiment, the present disclosure uses standardized open interfaces defined by the O-RAN Alliance to implement communication between RIC and base stations. Among these, E2 and M-Plane interfaces are the more important.

E2 interface: E2 interface is mainly used for control plane communication between near-real-time RIC (Near-RT RIC, Near Real-Time RIC) and base stations, supporting the following functions: (a) control plane message exchange: RIC can send control instructions to base stations through E2 interface, such as Resource Block (RB) allocation strategy adjustments and interference management instructions. E2 interface is the key communication path between RIC and base stations, responsible for transmitting near-real-time control messages. (b) user plane data support: E2 interface mainly transmits control plane messages, however, in some cases, it can also support the transmission of user plane performance indicators. (c) strategy updates: RIC can dynamically update and distribute new network optimization strategies through E2 interface to achieve more flexible network resource management.

The E2 interface adopts the concept of service models and defines multiple service types, such as: E2 Service Model (SM): defines message structures and processes for specific functions; E2 Application Protocol (E2AP): responsible for message transmission protocol of E2 interface, ensuring effective communication between RIC and base stations.

M-Plane interface, M-Plane interface is mainly used for communication between non-real-time RIC (Non-RT RIC) and base stations, responsible for the following functions: (a) configuration management: performing initialization configuration, software updates, parameter settings and other operations through M-Plane, helping service providers effectively manage basic settings of O-RAN equipment. (b) performance management: collecting long-term network performance statistics through M-Plane interface, these data are used for non-real-time network optimization decisions and strategy formulation. (c) fault monitoring and management: through M-Plane interface, operators can monitor and report fault conditions, perform fault isolation and recovery, so as to maintain stable network operation.

In the present disclosure, RIC obtains network status information from base stations in real-time through E2 interface and distributes dynamic RB allocation strategies. Meanwhile, it performs long-term performance optimization and configuration management through M-plane interface.

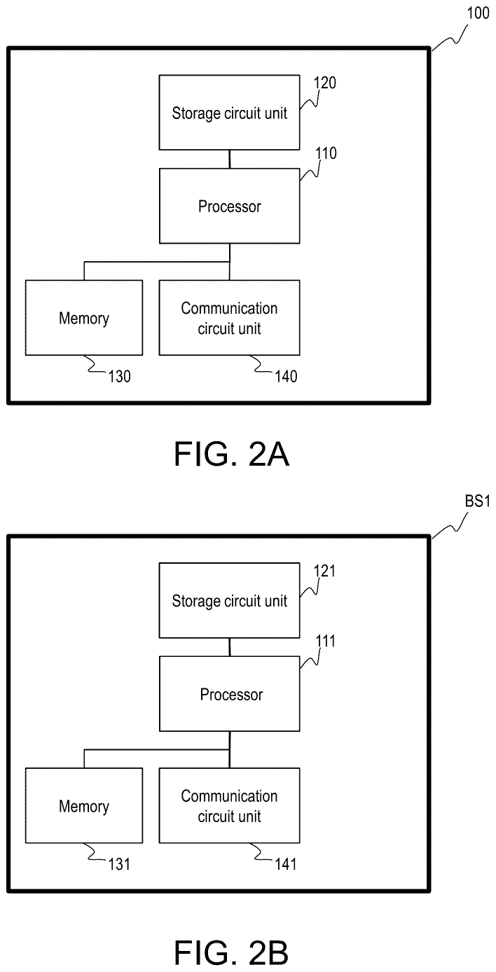

FIG. 2A is a block diagram of a Radio Access Network Intelligent Controller according to an embodiment of the present disclosure. FIG. 2B is a block diagram of a base station according to an embodiment of the present disclosure.

In one embodiment, as shown in FIG. 2A, RIC 100 includes: storage circuit unit 120: used for storing various data and program codes; processor 110: responsible for executing various computation and control functions; memory 130: used for temporarily storing data needed when processor 110 executes programs; communication circuit unit 140: used for communication connection with multiple base stations.

In one embodiment, processor 110 may implement the following functions by executing program code modules stored in storage circuit unit 120: obtaining network status information from multiple base stations, analyzing network status information, identifying interfered UEs, formulating dynamic Resource Block (RB) allocation strategies, transmitting strategies to corresponding base stations and/or updating strategies according to preset conditions.

Communication circuit unit 140 is responsible for receiving network status information from base stations and transmitting dynamic RB allocation strategies formulated by RIC to each base station.

Next, as shown in FIG. 2B, base station BS1's internal structure is similar to RIC 100, including: storage circuit unit 121, stores programs and data needed for base station operation; processor 111, executes various base station functions; memory 131, provides temporary data storage space for processor 111; communication circuit unit 141, responsible for information exchange with RIC 100, while also responsible for establishing wireless connections with multiple subordinate UEs, collecting UE measurement reports and other information.

In one embodiment, processor 111 of base station BS1 may implement the following functions by executing program codes stored in storage circuit unit 121: collecting and organizing network status information from subordinate UEs, transmitting network status information to RIC 100, receiving and executing dynamic RB allocation strategies from RIC 100, allocating appropriate RBs to subordinate UEs according to strategies.

Processors 110, 111, serving as central control units of RIC and base station, are responsible for coordinating the operation of various devices/modules/circuit components. Processors 110, 111 (for example, having processing circuit systems) may include intelligent hardware devices, such as Central Processing Unit (CPU), Microcontroller Unit (MCU), Field-Programmable Gate Array (FPGA), Application-Specific Integrated Circuit (ASIC), etc.

Storage devices 120, 121 are used to store data. Storage devices 120, 121 can record data that needs to be stored for a long time under the instruction of processors 110, 111, such as firmware or software for managing RIC and base stations, multiple program code modules, databases. In the present embodiment, storage device 200 can be any type of Hard Disk drive (HDD) or non-volatile memory storage device (such as Solid State Drive, SSD).

Memory 130, 131 can be Dynamic Random Access Memory (DRAM), Static Random Access Memory (SRAM), etc. However, it must be understood that the present disclosure is not limited to this, memory 130, 131 can also be other suitable memory.

In one embodiment, the communication circuit units 140 (located in RIC 100) and 141 (located in base station BS1) of the present disclosure adopt a multi-layer communication protocol architecture that covers all aspects from physical layer to application layer, mainly including the following aspects:
Physical layer protocol: At the physical layer, communication circuit units 140 and 141 can use Ethernet or optical fiber communication protocols. These protocols ensure high-speed, stable physical connections between RIC and base stations.
Data link layer protocol: At this layer, mainly using Ethernet protocol (IEEE 802.3) to manage data frame transmission.
Network layer protocol: IP (Internet Protocol) is widely used at this layer, specifically may adopt IPv4 or IPv6. IP protocol is responsible for data packet routing and addressing.

Transport layer protocol:
TCP (Transmission Control Protocol): used for control messages and large data transmission that require reliable transmission.
UDP (User Datagram Protocol): used for data transmission with high real-time requirements, such as certain monitoring data.
Application layer protocol: At the application layer, communication circuit units 140 and 141 mainly use dedicated protocols defined by the O-RAN Alliance:
(a) For E2 interface: E2AP (E2 Application Protocol): used for message exchange between near-real-time RIC and base stations. E2SM (E2 Service Model): defines specific message structures for different service types.
(b) For M-plane interface: NETCONF (Network Configuration Protocol): used for configuration management. YANG (Yet Another Next Generation): used for data modeling.
(c) Other supporting protocols: SCTP (Stream Control Transmission Protocol): used as transport layer protocol for E2AP in some cases. TLS/DTLS (Transport Layer Security/Datagram TLS): used for ensuring communication security.

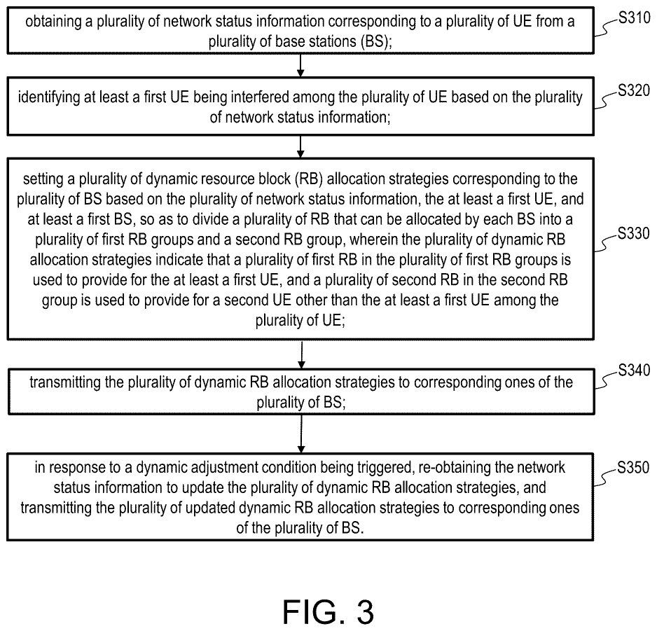

FIG. 3 is a flowchart of a dynamic Resource Block configuration method used by a Radio Access Network Intelligent Controller according to an embodiment of the present disclosure.

Wherein, the network status information includes: a plurality of Reference Signal Received Power (RSRP) values of a plurality of transmission pairs between each UE and the plurality of BSs respectively; a plurality of Reference Signal Received Quality (RSRQ) values of a plurality of transmission pairs between each UE and the plurality of BSs respectively; and a plurality of Signal-to-Interference-plus-Noise Ratio (SINR) values of a plurality of transmission pairs between each UE and the plurality of BSs respectively.

Referring to FIG. 3, processor 110 of RIC 100 executes multiple program code modules to implement the dynamic Resource Block configuration method: in step S310, obtaining a plurality of network status information corresponding to the plurality of UEs from the plurality of base stations (BS).

In one embodiment, the execution process of step S310 is as follows: RIC 100 obtains network status information from multiple base stations BS1 to BSN through its communication circuit unit 140, using O-RAN's E2 interface.

These network status information includes: UE Measurement Report (MR) and Key Performance Measurement (KPM).

In another embodiment, the present disclosure fully utilizes User Equipment (UE) Measurement Reports (MR) to obtain accurate network status information. MR is a report sent by UE periodically or triggered by specific events to its serving base station, containing UE's measurements of surrounding radio environment. MR contains one or more of the following key information: a plurality of Reference Signal Received Power (RSRP) values of a plurality of transmission pairs between each UE and the plurality of BSs respectively; a plurality of Reference Signal Received Quality (RSRQ) values of a plurality of transmission pairs between each UE and the plurality of BSs respectively; and a plurality of Signal-to-Interference-plus-Noise Ratio (SINR) values of a plurality of transmission pairs between each UE and the plurality of BSs respectively.

In an embodiment, MR includes two parts: Serving Cell Measurements and Neighbor Cell Measurements.
(1) Serving Cell Measurements: RSRP (Reference Signal Received Power), represents the power value of reference signal received by UE from serving cell, reflecting signal strength, and higher value indicates stronger signal; RSRQ (Reference Signal Received Quality), represents the quality of reference signal received by UE from serving cell, usually the ratio between signal power and noise, and higher value indicates better signal quality; SINR (Signal-to-Interference-plus-Noise Ratio), represents the ratio between signal received by UE and interference plus noise. Higher value indicates better signal quality, meaning better communication performance.
(2) Neighbor Cell Measurements: Neighbor cell list: contains identifications of all neighboring cells measured by UE and their corresponding measurement values; RSRP and RSRQ, similar to serving cell, reporting RSRP and RSRQ of neighboring cells, helping base station determine signal quality and strength of neighboring cells; SINR, reporting SINR values of neighboring areas, helping base station understand interference and noise conditions of neighboring areas.

In one embodiment, KPM is a mechanism in O-RAN architecture for collecting and reporting network performance data. The purpose is to provide real-time and historical information of network status for network optimization and management. KPM provides necessary information for RIC to make intelligent decisions. KPM includes but is not limited to one or more of the following measurements: SS-SINR: Synchronization Signal Signal-to-Interference-plus-Noise Ratio; SS-RSRP: Synchronization Signal Reference Signal Received Power; SS-RSRQ: Synchronization Signal Reference Signal Received Quality.

In step S320, identifying at least one first UE being interfered among the plurality of UEs based on the plurality of network status information.

Specifically, in one embodiment, the execution process of step S320 is as follows: processor 110 of RIC 100 executes interference identification module stored in storage device 120 to analyze network status information obtained in step S310.

In one embodiment, RIC 100's process of identifying interfered UE (i.e., first UE) is as follows: first, calculating RSRP differences between the plurality of transmission pairs according to each UE's plurality of RSRP values of the plurality of transmission pairs. Then, RIC will set a preset RSRP threshold value. When determining that at least one RSRP difference of a UE is less than this preset RSRP threshold value, RIC will identify that UE as an interfered first UE. This method can effectively identify UEs with poor signal quality that may be experiencing interference.

For example, processor 110 calculates RSRP differences for each UE according to the following formula: (RSRP difference)_{AX} (e.g., RSRP_{AX})=|(RSRP_{A} between UE4 and serving base station A)−(RSRP_{X} between UE4 and target base station X)|.

Furthermore, processor 110 sets RSRP difference threshold value, for example, 12 dBm.

Then, for each UE, processor 110 determines whether there exists an RSRP difference less than the threshold value. If exists, that UE is identified as an interfered first UE. Finally, processor 110 can store the calculated plurality of RSRP differences corresponding to the plurality of UEs and corresponding identification results in memory 130.

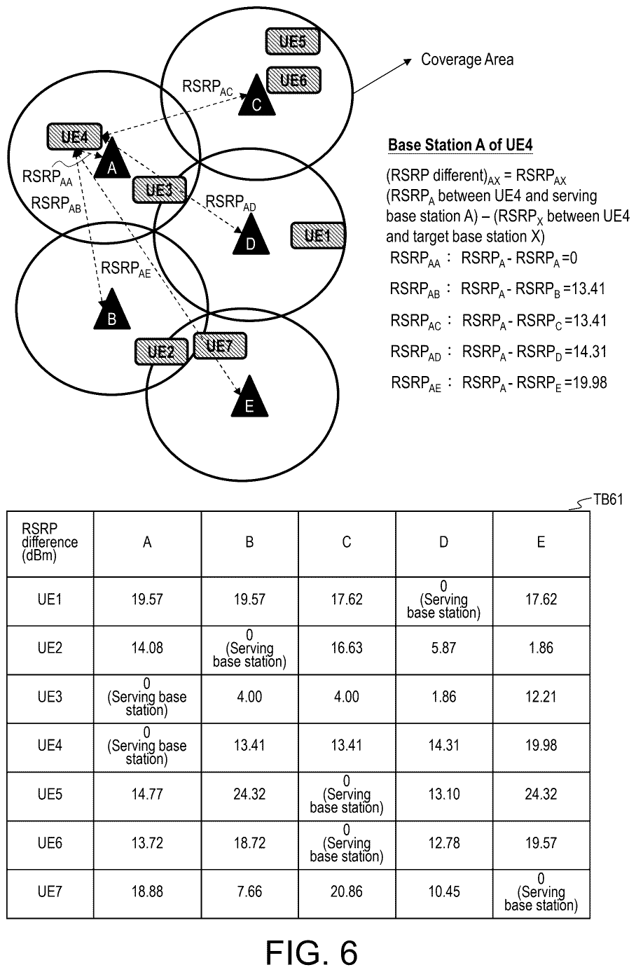

FIG. 6 is a diagram illustrating multiple UEs within coverage areas of multiple base stations and corresponding RSRP differences according to an embodiment of the present disclosure. Referring to FIG. 6, in one embodiment, as shown in the upper part of FIG. 6, assume the wireless communication system includes base stations A-E, and there are multiple UE1-UE7 within the coverage areas of these base stations A-E.

In one embodiment, coverage area can be estimated through each base station's radio output power and location. For example, RIC can obtain each base station's transmission power (Power) and location through O-RAN standard interface; then, based on transmission power, RIC can estimate each base station's coverage area (Coverage), also called service area; finally, RIC can use each base station's coverage area to determine whether they overlap. For example, if base station A's power can reach 150 m, base station B's power can reach 150 m, and the distance between A and B is 200 m, RIC can determine that A and B's coverage areas overlap. In another embodiment, each base station's transmission power (Power), corresponding coverage area/distance and location can also be preset, RIC can directly obtain this information from database.

RIC can obtain RSRP of corresponding multiple transmission pairs for each UE according to network status information, and thereby calculate RSRP differences between multiple transmission pairs of each UE. For example, taking UE4 as an example, the RSRP difference between UE4's transmission pair with serving base station A and UE4's transmission pair with target base station B is RSRP_{AB}=(RSRP_{A} between UE4 and serving base station A)−(RSRP_{B}between UE4 and target base station B), the calculation result as shown in table TB61:13.41. Similarly, RSRP_{AC}=13.41; RSRP_{AD}=14.31; RSRP_{AE}=19.98. It should be noted that when the target base station equals the serving base station, the obtained difference must be 0. In an embodiment, larger RSRP difference can also reflect that the UE is either farther from the corresponding target base station or has weaker signal (because RSRP value is smaller).

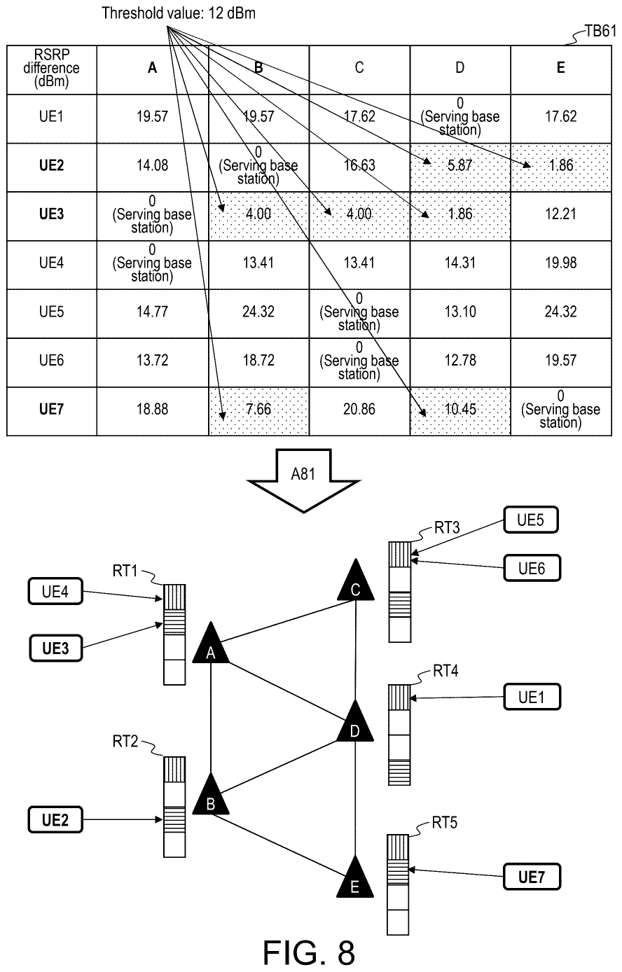

For example, referring to table TB61 in the upper part of FIG. 8, assuming RSRP difference threshold value (preset threshold value) is 12 dBm. According to this RSRP difference threshold value, processor 110 can identify that multiple RSRP differences corresponding to UE2 are less than RSRP difference threshold value 12 dBm, thereby determining that UE2, UE3, UE7 are interfered and classified as interfered first UEs.

In step S330, setting a plurality of dynamic Resource Block (RB) allocation strategies corresponding to the plurality of BSs based on the plurality of network status information, the at least one first UE, and at least one first BS, so as to divide a plurality of RBs that can be allocated by each BS into a plurality of first RB groups and a second RB group, wherein the plurality of dynamic RB allocation strategies indicate that: a plurality of first RBs in the plurality of first RB groups is used to provide for the at least one first UE, and a plurality of second RBs in the second RB group is used to provide for a second UE other than the at least one first UE among the plurality of UEs. After setting the plurality of dynamic Resource Block (RB) allocation strategies corresponding to the plurality of BSs, in step S340, transmitting the plurality of dynamic RB allocation strategies to corresponding ones of the plurality of BSs.

In an embodiment, setting the plurality of dynamic RB allocation strategies corresponding to the plurality of BSs further includes: identifying a plurality of distances between each of the BSs; identifying a coverage area of each of the BSs. As such, the relative position relationships, neighboring relationships/overlapping relationships between these BSs can be determined.

Then, RIC 100, for one target BS among the plurality of BSs, identifies at least one neighboring BS according to the plurality of distances and coverage areas of the plurality of BSs, wherein the coverage area of the at least one neighboring BS partially overlaps with the coverage area of the target BS; determines a number of the plurality of first RB groups according to a number of the at least one neighboring BS and overlapping relationships between the at least one neighboring BS; determines a first number of the plurality of first RBs in the plurality of first RB groups and a second number of the plurality of second RBs in the second RB group according to the number of the plurality of first RB groups and a number of the second RB group, wherein the plurality of first RBs is divided (e.g., evenly divided) into the plurality of first RB groups based on the number of the plurality of first RB groups; and sets and generates the plurality of dynamic RB allocation strategies to set the plurality of first RB groups and the second RB group to the target BS and the at least one neighboring BS respectively, wherein a target first RB group being set to the target BS among the plurality of first RB groups is different from neighboring first RB groups being set to each neighboring BS among the plurality of first RB groups, and the neighboring first RB groups of two BSs that are not neighboring to each other among the at least one neighboring BS are identical, wherein the second RB group being set to the target BS and the at least one neighboring BS is identical.

In an embodiment, processor 110 of RIC 100 executes resource allocation module to set dynamic RB allocation strategies for each base station: identifying coverage area and neighboring relationships of each base station; using complete graph concepts to ensure interference area RBs of neighboring base stations do not overlap; according to identified neighboring relationships and overlapping relationships between multiple base stations, dynamically adjusting the number/ratio of interference areas and non-interference areas, for example: interference area (also called first RB group): 75% of RBs; non-interference area (also called second RB group): 25% of RBs.

Then, processor 110 generates specific RB allocation strategies for each base station, including: first RB group: allocated to interfered first UEs; second RB group: allocated to non-interfered second UEs. Finally, processor 110 stores generated strategies in memory 130.

In one embodiment, RIC identifies a plurality of distances between each BS and coverage area of each BS. Then, for one target BS among multiple BSs, RIC identifies at least one neighboring BS according to multiple distances and coverage areas of multiple BSs, wherein coverage areas of these neighboring BSs partially overlap with coverage area of target BS. Then, RIC determines number of multiple first RB groups based on number of neighboring BSs and overlapping relationships between them. Based on number of first RB groups and number of second RB group, RIC determines number of multiple first RBs in first RB groups and number of multiple second RBs in second RB group, wherein multiple first RBs are evenly divided into multiple first RB groups based on number of first RB groups.

In an embodiment the present disclosure will determine a neighboring relationship (which can be visualized as a relationship graph) according to target BS, number of neighboring BSs and their relative positions and overlapping relationships, then determine number of multiple first RB groups based on this neighboring relationship, and thereby determine the proportion of each RB group among overall allocatable RBs.

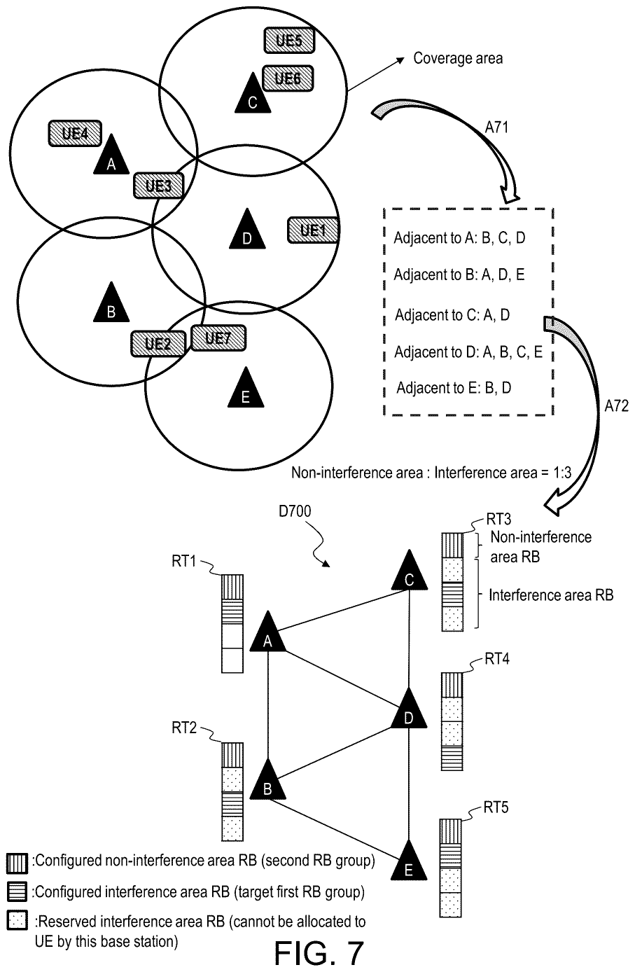

FIG. 7 is a diagram illustrating the relationship graph determined according to coverage areas and overlapping relationships of multiple base stations and setting corresponding dynamic RB configuration strategies according to an embodiment of the present disclosure.

For example, as shown in FIG. 7, the present disclosure proposes a dynamic Resource Block (RB) allocation method based on network topology. This method first establishes a relationship graph D700 between base stations, then designs RB allocation strategies for interference areas and non-interference areas based on this relationship graph.

First, RIC establishes a network structure diagram containing 5 base stations (A, B, C, D, E) through analyzing network topology information. Each base station has its corresponding coverage area, shown as circular areas in the figure. RIC analyzes the overlapping situations of these coverage areas and determined neighboring relationships between base stations, establishing the following neighboring relationship list, as indicated by arrow A71: Adjacent to A: B, C, D; Adjacent to B: A, D, E; Adjacent to C: A, D; Adjacent to D: A, B, C, E; Adjacent to E: B, D.

Based on these neighboring relationships, RIC constructs a relationship graph D700 (e.g., complete graph), where each base station is connected with its neighboring base stations. This relationship graph D700 provides important basis for subsequent RB allocation strategies.

Next, processor 110 designs RB allocation strategy according to relationship graph D700, determining that the maximum absolute number of neighbors corresponding to one base station is 2. Taking base station A as an example, base stations B, C, D are adjacent to base station A, number of neighbors is 3; among them, non-adjacent base station pair is base stations B, C, quantity is 1; RIC can obtain absolute number of neighbors as 2 (3−1=2). Then, processor 110 calculates number of required interference areas as absolute number of neighbors plus 1 (base station A itself), i.e., number of required interference areas is 3; and calculates total number of groups for all allocatable RBs as number of required interference areas plus number of non-interference areas (i.e., 3+1=4), obtaining total number of groups 4. At this point, processor 110 can evenly divide all allocatable RBs into 4 areas according to total number of groups 4, where 1 area is non-interference area, where 3 areas are interference areas. These three interference areas can be set respectively to base station A and its neighboring base stations B, C, D (see horizontal striped blocks in tables RT1, RT2, RT3, RT4).

For example, in this example, as indicated by arrow A72, RIC divides each base station's available RBs into non-interference areas and interference areas in ratio of 1:3. This means 25% of RBs are allocated as non-interference area, 75% as interference area.

In dynamic RB allocation strategy corresponding to base station A:
Non-interference area RBs corresponding to base station A (vertical striped blocks in table RT1, also called second RB group): This part of RBs can be allocated by base station A to UEs within its coverage area that are identified to use non-interference area RBs. In this embodiment, processor 110 allocates identical non-interference area RBs to each base station.

Interference area RBs (also called first RB group): In this example, there are 3 sets of preset non-interference area RBs, corresponding to neighboring relationships with B, C, D. This ensures that A has a dedicated set of RBs with each of its neighboring base stations that can be used without causing interference.

Interference area RBs can be further divided into two categories: (a) non-interference area RBs set for base station (e.g., base station A) (e.g., horizontal striped blocks in table RT1 corresponding to base station A): these RBs are designated for specific combinations of neighboring base stations to avoid interference; (b) reserved interference area RBs (e.g., dotted blocks in table RT1 corresponding to base station A): these RBs are not set for base station A to use because they have been set for neighboring base stations of base station A.

RB allocation strategies for other base stations (B, C, D, E) follow similar principles, as shown in RT2 to RT5. Processor 110 will set specific interference area RBs for each base station to match each base station's unique neighboring relationships.

In one embodiment, the present disclosure proposes a special Resource Block (RB) allocation strategy, specifically targeting certain specific base station topology structures. Taking base station A as an example, its neighboring base stations B and C form a special base station pair. The two members of this base station pair, B and C, although both adjacent to A, are not adjacent to each other. This unique topology structure provides an optimization opportunity for RB allocation, namely, processor 110 will set the interference area RBs for this base station pair to the same group (see horizontal striped blocks in RT2, RT3).

This setting is based on the following considerations:
Space multiplexing efficiency: Since base stations B and C are not adjacent to each other, the possibility of direct interference between them is greatly reduced. This means B and C can use the same RB resources simultaneously without causing significant interference to each other. This space multiplexing strategy can significantly improve spectrum utilization.
Interference management: Although both B and C are adjacent to A, their use of the same interference area RBs will not increase A's interference burden. Because whether B and C use the same RBs or not, A needs to consider potential interference from both directions. By allocating B and C to the same interference area RBs, the system actually simplifies A's interference management task.
Reduced complexity: By allowing non-adjacent base station pairs to share interference area RBs, the RB allocation scheme for the entire network can become simpler. This not only reduces the complexity of resource management but may also reduce system computational burden.
Adapting to network topology: This allocation method fully utilizes the actual physical topology of the network. It recognizes that although B and C are both adjacent to A, the geographical distance between them may be large enough to allow spectrum reuse.
Potential performance improvement: In some cases, this allocation may lead to increased overall network capacity. For example, if B and C's traffic demands are complementary (i.e., when B needs more resources, C's demand is lower, and vice versa), their sharing of the same interference area RBs can achieve higher resource utilization of RBs. That is, it can make the size of each RB group larger.

Through this method, RIC can formulate an RB allocation strategy for each base station that both minimizes interference and flexibly responds to network demand changes. This strategy not only improves spectrum utilization efficiency but also enhances network resistance to interference, thereby improving overall network performance.

In one embodiment, setting and generating the plurality of dynamic RB allocation strategies comprises: allocating at least one target UE corresponding to the target BS to the target first RB group or the second RB group being set based on whether the at least one target UE corresponding to the target BS is interfered; and allocating at least one neighboring UE corresponding to each neighboring BS to the neighboring first RB group or the second RB group being set based on whether the at least one neighboring UE of each neighboring BS is interfered.

FIG. 8 is a diagram illustrating setting dynamic RB configuration strategies to allocate different RB groups to multiple UEs according to interference conditions of multiple UEs according to an embodiment of the present disclosure. RIC 100 sets a threshold value of 12 dBm. When RSRP difference is less than this threshold value, it indicates that UE may be experiencing interference. In table TB61, these potential interference situations are marked with dotted shading.

For example, continuing from the example in FIG. 7, according to table TB61 and threshold value 12 dBm, processor 110 can identify that interfered first UEs are UE2, UE3, UE7, belonging to base station B, base station A, base station E respectively, these first UEs will be allocated respectively to interference area RBs (target first RB group) of corresponding serving base stations; processor 110 can also identify non-interfered second UEs as UE1, UE4, UE5, UE6, belonging to base station D, base station A, base station C, base station C respectively, these second UEs will be allocated respectively to non-interference area RBs (second RB group) of corresponding serving base stations. Therefore, as indicated by arrow A81, processor 110 will finally set dynamic RB allocation strategies corresponding to multiple base stations: dynamic RB allocation strategy corresponding to base station A, as shown in table RT1, where UE4 is allocated to non-interference area RBs, UE3 is allocated to interference area RBs set for base station A; dynamic RB allocation strategy corresponding to base station B, as shown in table RT2, where UE2 is allocated to interference area RBs set for base station B; dynamic RB allocation strategy corresponding to base station C, as shown in table RT3, where UE5, UE6 are allocated to non-interference area RBs; dynamic RB allocation strategy corresponding to base station D, as shown in table RT4, where UE1 is allocated to non-interference area RBs; dynamic RB allocation strategy corresponding to base station E, as shown in table RT5, UE7 is allocated to interference area RBs set for base station E.

After setting dynamic RB strategies corresponding to these base stations, RIC 100 will transmit these dynamic RBs to corresponding base stations.

That is, RIC 100 transmits a target dynamic RB allocation strategy corresponding to the target BS (e.g., base station A) among the plurality of dynamic RB allocation strategies to the target BS, wherein the target dynamic RB allocation strategy is used to: indicate allocatable RBs of the target BS are adjusted from the plurality of RBs to the target first RB group and the second RB group; and indicate that at least one target UE corresponding to the target BS is allocated to the target first RB group or the second RB group respectively.

Furthermore, RIC 100 transmits neighboring dynamic RB allocation strategies corresponding to each neighboring BS among the plurality of dynamic RB allocation strategies to the neighboring BS (e.g., neighboring base stations B, C, D relative to base station A), wherein the neighboring dynamic RB allocation strategies are used to: indicate allocatable RBs of the neighboring BS are adjusted from the plurality of RBs to the neighboring first RB group and the second RB group; and indicate that at least one neighboring UE corresponding to the neighboring BS is allocated to the neighboring first RB group or the second RB group respectively.

In one embodiment, base stations will allocate their subordinate UEs to designated RB groups according to received dynamic RB allocation strategies.

More specifically, after the target BS receives the target dynamic RB allocation strategy, the target BS identifies the target first RB group being set to the target BS among the plurality of first RB groups and at least one target first UE being allocated to the target first RB group among the at least one target UE according to the target dynamic RB allocation strategy; the target BS identifies the second RB group and at least one target second UE being allocated to the second RB group among the at least one target UE according to the target dynamic RB allocation strategy; the target BS allocates a plurality of target first RBs in the target first RB group to the at least one target first UE according to the target dynamic RB allocation strategy, so as to make at least one target first RB being allocated to each of the at least one target first UE different; and the target BS allocates the plurality of second RBs in the second RB group to the at least one target second UE according to the target dynamic RB allocation strategy, so as to make at least one second RB being allocated to each of the at least one target second UE different. The operation of neighboring base stations allocating their subordinate UEs according to received neighboring dynamic RB allocation strategies is similar to target base station, and will not be repeated here.

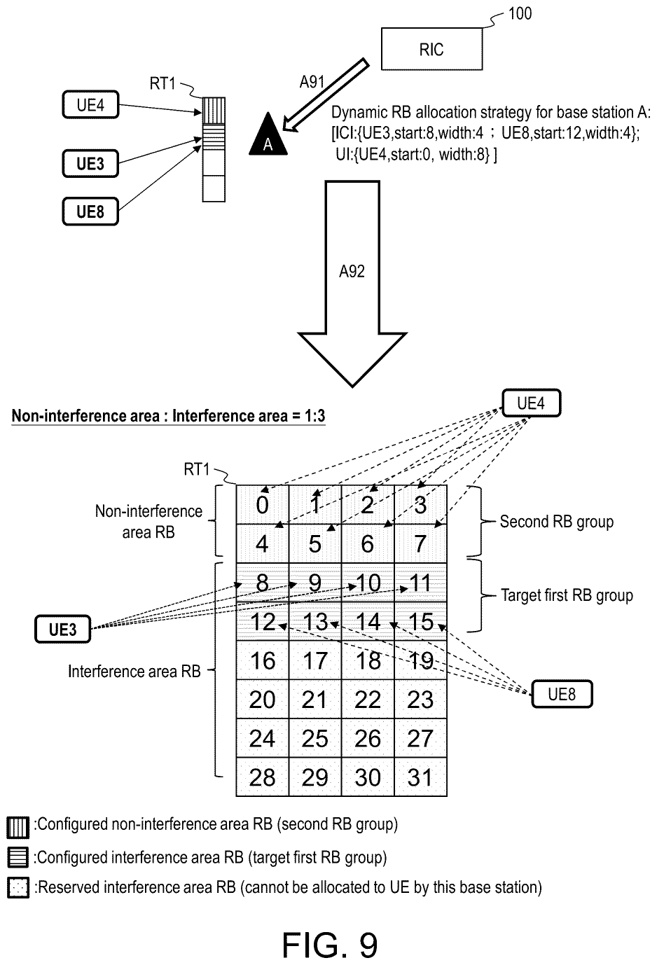

FIG. 9 is a diagram illustrating allocating different UEs to corresponding RB groups according to received dynamic RB configuration strategies according to an embodiment of the present disclosure.

Referring to FIG. 9, for example, assume RIC 100 formulated dynamic RB configuration strategy for base station A based on network status information, and transmit to base station A through instructions shown in A91. RIC will notify each base station through dynamic RB configuration strategy how to divide all RBs into interference areas (ICI) and non-interference areas (UI). Each area will be given starting RB and width (length).

Furthermore, assume base station A has UE3, UE4, UE8 under it, and the received dynamic RB allocation strategy is: [ICI: {UE3, start: 8, width: 4; UE8, start: 12, width: 4}; UI: {UE4, start: 0, width: 8}] (as indicated by arrow A91), where ICI indicates interference area allocation strategy, UI indicates non-interference area allocation strategy.

In an embodiment, this strategy contains two main parts (see table RT1 in FIG. 9):
(1) Interference area (ICI): UE3 is allocated 4 RBs starting from position 8; UE8 is allocated 4 RBs starting from position 12.
(2) Non-interference area (UI): UE4 is allocated 8 RBs starting from position 0.

After receiving this strategy, base station A performed RB allocation as shown in A92. After this setting, base station A's total allocatable RBs is 16, that is, 8 RBs for non-interference area, 8 RBs for interference area, where RB0-7 are non-interference area RBs (second RB group), RB8-15 are interference area RBs (target first RB group) set for base station A.

In this embodiment, base station A will make RBs used by each UE not overlap with each other. Base station A's RB allocation process is as follows:
Non-interference area RB allocation (RB 0-7): According to the strategy, base station A will identify UE4 is allocated to non-interference area RBs, and UE4 is allocated all 8 non-interference area RBs (numbered 0-7). This allocation method make UE4 can use these RBs without interference, beneficial for improving its transmission quality.

Interference area RB allocation (RB 8-15): According to the strategy, base station A will identify UE3, 8 are allocated to non-interference area RBs. Furthermore, base station A can allocate UE3 to RB 8-11 based on RB allocation strategy's suggestion, corresponding to “start: 8, width: 4” in the strategy; allocate UE8 to RB 12-15, corresponding to “start: 12, width: 4” in the strategy.

Base station A can also use allocation methods not suggested by the strategy to allocate its subordinate UEs assigned to interference area RBs. For example, base station A further allocates RB8, RB9 to UE3 which has lower transmission demand, and allocates RB10˜15 to UE8 which has higher transmission demand, based on transmission demands of UE3, UE8. However, base station A will still follow RB allocation strategy's instruction to allocate UE3, UE8 to interference area RBs, only allocating UE3, UE8 to set interference area RBs, not allocating UE3, UE8 to non-interference area RBs.

In one embodiment, if base station A accepts a new UE9, base station A can evaluate UE4's resource demands based on transmission status with UE9, considering whether to allocate part of non-interference area RBs to UE9. In another embodiment, base station A may need to request RIC to update dynamic RB configuration strategy (while transmitting network status information about UE9) to adapt to the addition of UE9. RIC may re-evaluate UE9's interference situation corresponding to entire network/base station, and provide new RB allocation strategy for base station A. That is, how to allocate interference areas and non-interference areas to corresponding UEs is each BS's responsibility.

Finally in step S350, in response to a dynamic adjustment condition being triggered, re-obtaining the network status information to update the plurality of dynamic RB allocation strategies, and transmitting the plurality of updated dynamic RB allocation strategies to corresponding ones of the plurality of BSs.

In one embodiment, the dynamic adjustment condition comprises: determining that a preset time period is reached; determining that a network load change exceeds a preset threshold; receiving an abnormal status report from at least one BS; receiving an RB allocation strategy update request from at least one BS; detecting that a new BS joins or an existing BS goes offline; or detecting that a network topology corresponding to the wireless communication system changes.

In one embodiment, RIC can set reporting period for base stations to report data to it, this reporting period or preset time period used to update dynamic adjustment conditions can be dynamically adjusted according to different scenarios. For example, in densely populated areas, reporting period/preset time period may need to be shorter to respond to more frequent interference situations. In sparsely populated areas, reporting period/preset time period can be appropriately extended.

In one embodiment, RIC 100 periodically re-evaluates network conditions and may adjust RB allocation strategies for various BSs. When network conditions change significantly (such as sudden load increase or certain BS going offline), RIC 100 may send updated decisions to relevant BSs. Furthermore, after receiving new decisions, BS needs to rearrange RB allocation but will try to minimize interference to existing connections.

In one embodiment, BS continuously monitors performance indicators of UEs under its management, such as throughput, latency, etc. Then, BS periodically reports these performance indicators to RIC 100. RIC 100 evaluates the effectiveness of current RB allocation strategy based on received performance reports. If performance degradation or optimization opportunities are found, RIC 100 may adjust RB allocation strategy. Adjusted strategy is then distributed again to relevant BSs for execution.

In one embodiment, when a BS suddenly goes offline or fails: RIC determines that BS has failed if it does not receive periodic reports from that BS, then RIC recalculates relationship graph and quickly formulates new RB allocation strategy; new strategy will consider how to take over failed BS's UEs while minimizing interference to existing network. Furthermore, when sudden high traffic demands appear in network (such as large events): RIC may temporarily adjust ratio between interference areas and non-interference areas; allocate more RB resources to high traffic areas (for example, if a base station has more UEs allocated to interference area RBs, can dynamically increase the proportion of interference area RBs for that base station).

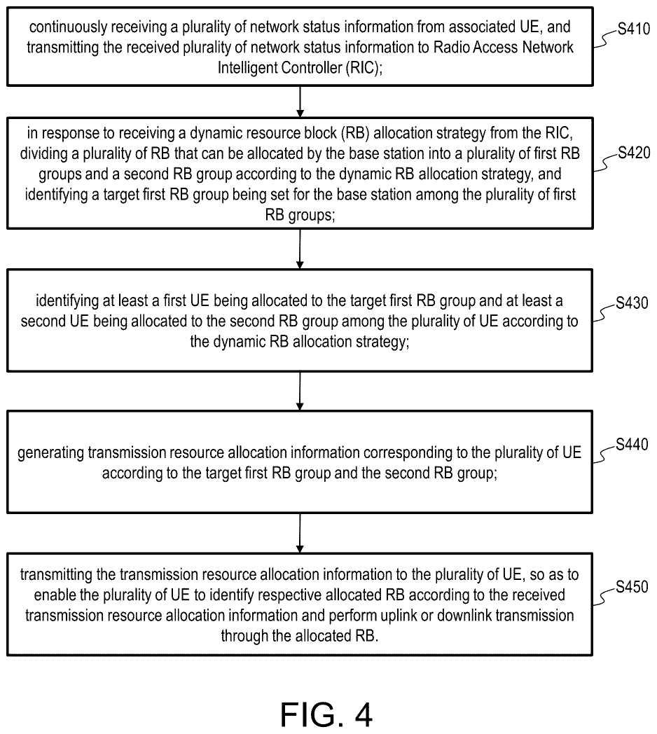

The following uses FIG. 4 to explain base station's operation process in the present disclosure.

FIG. 4 is a flowchart of base station operation according to an embodiment of the present disclosure. Referring to FIG. 4, in step S410, base station continuously receives a plurality of network status information from associated plurality of UEs and transmits the received plurality of network status information to Radio Access Network Intelligent Controller (RIC). In this step, base station continuously receives multiple pieces of network status information from multiple User Equipment (UE) within its coverage area. This information may include Reference Signal Received Power (RSRP), Reference Signal Received Quality (RSRQ), or Signal-to-Interference-plus-Noise Ratio (SINR) for each UE, etc. Base station integrates this information and transmits it to Radio Access Network Intelligent Controller (RIC) through O-RAN standard interface.

In step S420, in response to receiving a dynamic Resource Block (RB) allocation strategy from the RIC, dividing a plurality of RBs that can be allocated by the base station into a plurality of first RB groups and a second RB group according to the dynamic RB allocation strategy, and identifying a target first RB group being set to the base station among the plurality of first RB groups. In this step, base station receives dynamic RB allocation strategy from RIC. According to this strategy, base station divides its allocatable multiple RBs into multiple first RB groups and a second RB group. Among them, multiple first RB groups are set as target first RB group, used for allocation to UEs that may experience interference. The second RB group is used for allocation to non-interfered UEs.

In step S430, identifying at least one first UE being allocated to the target first RB group and at least one second UE being allocated to the second RB group among the plurality of UEs according to the dynamic RB allocation strategy. In this step, base station identifies at least one first UE (potentially interfered UE) that needs to be allocated to target first RB group and at least one second UE (non-interfered UE) that needs to be allocated to second RB group according to received dynamic RB allocation strategy. This identification process is based on strategy provided by RIC, which considers interference situation of each UE.

In step S440, generating transmission resource allocation information corresponding to the plurality of UEs according to the target first RB group and the second RB group. In this step, base station generates corresponding transmission resource allocation information for multiple UEs according to division of target first RB group and second RB group. This information specifies specific RB range that each UE can use, including starting RB number and RB quantity.

In step S450, transmitting the transmission resource allocation information to the plurality of UEs, so as to enable the plurality of UEs to identify respective allocated RBs according to the received transmission resource allocation information and perform uplink or downlink transmission through the allocated RBs. In this step, base station transmits generated transmission resource allocation information to corresponding UEs. After receiving this information, each UE can identify specific RBs allocated to itself. UE can then use these allocated RBs for uplink or downlink data transmission.

In one embodiment, base station sends transmission resource allocation information to UE through control channel (such as PDCCH, Physical Downlink Control Channel). This transmission resource allocation information contains instructions for UE to perform uplink or downlink transmission on specific time-frequency resources. UE determines resources it can use according to received transmission resource allocation information, rather than directly receiving RB allocation information.

In one embodiment, the transmission resource allocation information contains: corresponding UE identifier; time-frequency position indication of RBs allocated to that UE; transmission direction (uplink/downlink) indication; Modulation and Coding Scheme (MCS) indication.

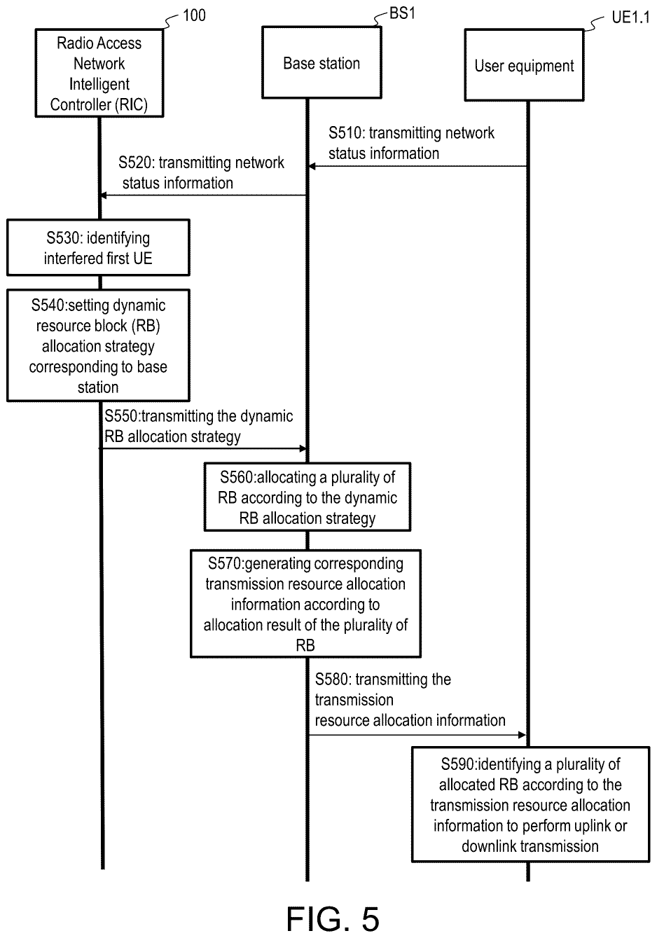

FIG. 5 is a sequence diagram of wireless communication system according to an embodiment of the present disclosure.

In one embodiment, as shown in FIG. 5, the present disclosure proposes a dynamic Resource Block (RB) allocation method based on O-RAN architecture. The following uses interaction process between Radio Access Network Intelligent Controller (RIC) 100, base station BS1 and User Equipment UE1.1 to explain this method.

S510: User Equipment UE1.1 continuously measures surrounding radio environment and transmits network status information to its serving base station BS1. This information, such as Measurement Report (MR), typically includes parameters like Reference Signal Received Power (RSRP), Reference Signal Received Quality (RSRQ), and Signal-to-Interference-plus-Noise Ratio (SINR).

S520: Base station BS1 collects network status information from UE1.1 and combines it with its own Key Performance Measurements (KPM) information. KPM contains parameters such as Synchronization Signal Signal-to-Interference-plus-Noise Ratio (SS-SINR), Synchronization Signal Reference Signal Received Power (SS-RSRP), and Synchronization Signal Reference Signal Received Quality (SS-RSRQ). Base station BS1 transmits this comprehensive information to Radio Access Network Intelligent Controller (RIC) 100 through O-RAN standard interface.

S530: RIC 100 analyzes this data to identify potentially interfered UEs after receiving network status information. This identification process typically involves comparing RSRP differences with preset RSRP difference threshold value (such as 12 dBm). If RSRP difference is less than preset RSRP difference threshold value, that UE is considered as an interfered first UE.

S540: Based on identification results and overall wireless communication system conditions, RIC 100 designs dynamic RB allocation strategy for base station BS1. This strategy divides BS1's available RBs into multiple first RB groups (for interfered UEs) and a second RB group (for non-interfered UEs).

S550: RIC 100 transmits the formulated dynamic RB allocation strategy to base station BS1 through E2 interface.

S560: After receiving RB allocation strategy, base station BS1 divides its available RBs into multiple first RB groups and a second RB group according to strategy instructions. For example, it might allocate 75% of RBs as interference area (first RB group), 25% as non-interference area (second RB group).

S570: Base station BS1 generates specific transmission resource allocation information for each UE according to RB allocation results. This includes allocating resources from first RB group to interfered UEs and from second RB group to non-interfered UEs.

S580: Base station BS1 transmits generated transmission resource allocation information to each UE, including UE1.1.

S590: After receiving transmission resource allocation information, UE1.1 identifies specific RBs allocated to itself. UE1.1 then uses these allocated RBs for uplink or downlink data transmission.

This process is dynamic and cyclic. RIC 100 periodically updates RB allocation strategies to adapt to changes in wireless communication system. Meanwhile, all UEs and base stations in wireless communication system continuously monitor and report network status, ensuring RIC 100 can make optimized decisions based on latest situations.

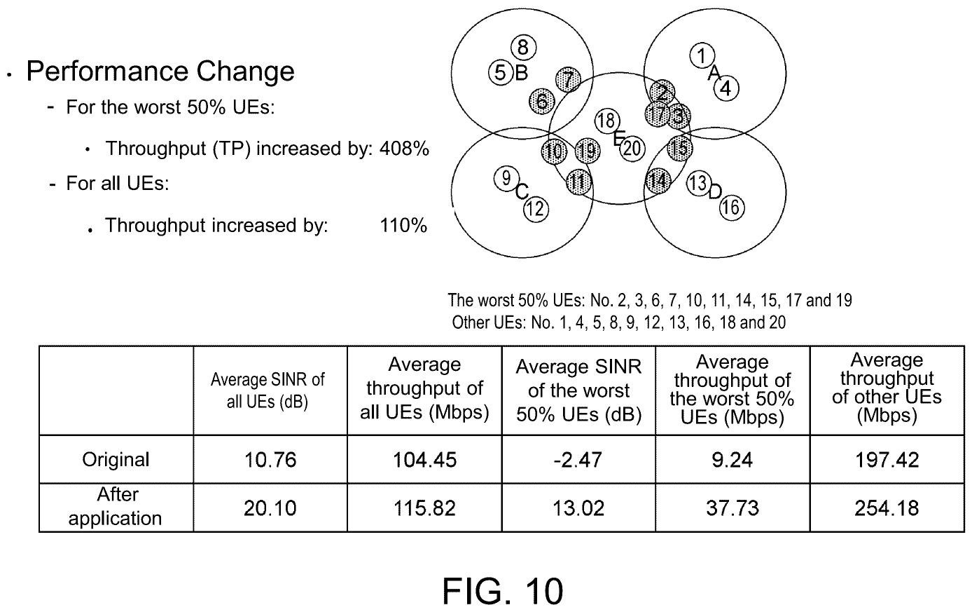

FIG. 10 is a diagram illustrating experimental results of applying this method according to an embodiment of the present disclosure.

Referring to FIG. 10, in one embodiment, the dynamic Resource Block (RB) allocation method was tested in a network scenario containing 20 User Equipment (UE). As shown in the figure, these UEs are distributed within coverage areas of 5 base stations (A, B, C, D, E), with some UEs located at edges or overlapping areas of base station coverage areas.

According to the method of the present disclosure, RIC first identifies UEs experiencing most severe interference. In this example, UEs identified as severely interfered include numbers 2, 3, 6, 7, 10, 11, 14, 15, 17 and 19, totaling 10 UEs, accounting for 50% of total. These UEs are mainly distributed at edges or overlapping areas of base station coverage areas, thus more susceptible to interference.

In this embodiment, RIC subsequently generated dynamic RB allocation strategy, and after implementing dynamic RB allocation strategy, network performance improved significantly:
1. For the worst 50% of UEs (i.e., most severely interfered UEs):
Average SINR improved from −2.47 dB to 13.02 dB, an improvement of 15.49 dB.
Average throughput increased from 9.24 Mbps to 37.73 Mbps, an increase of 408%.
2. For all UEs:
Average SINR improved from 10.76 dB to 20.10 dB, an improvement of 9.34 dB.
Average throughput increased from 104.45 Mbps to 115.82 Mbps, an increase of 110%.
3. For other 50% of UEs (non-severely interfered UEs):
Average throughput increased from 197.42 Mbps to 254.18 Mbps, an increase of 28.75%.

This experiment highlights several key utilities of the present disclosure:
Significant improvement in overall network performance: Through intelligent resource allocation, the entire network's average throughput increased by 110%, and SINR also showed substantial improvement.

Particularly improved experience for interfered users: Performance improvement for the worst 50% of UEs was especially notable, with throughput increasing by 408%, greatly improving these users'network experience.

Balanced performance improvement: Although focus was on improving performance of interfered UEs, other UEs'performance also improved, demonstrating this method's balance in overall network optimization.

Improved spectrum utilization efficiency: Overall performance improvement was achieved through RB allocation without increasing spectrum resources, indicating significant improvement in spectrum utilization efficiency.

For technical problems encountered in this field, the technical solution proposed by the present disclosure has the following technical effects:
Improved spectrum utilization: The present disclosure effectively improves spectrum resource utilization by dynamically dividing each base station (BS)'s allocatable Resource Blocks (RB) into multiple first RB groups and one second RB group, and allocating based on User Equipment (UE)'s interference conditions.
Reduced interference: By identifying interfered UEs and allocating them to dedicated first RB groups, network interference problems can be effectively reduced, improving overall network performance. Furthermore, multiple first RB groups are allocated to the plurality of BSs according to neighboring relationships between multiple BSs.
Strong dynamic adaptability: The RAN Intelligent Controller (RAN Intelligent Controller, RIC) of the present disclosure can dynamically adjust RB allocation strategies based on network status information, enabling the system to quickly respond to changes in network environment. Introduction of dynamic adjustment condition mechanism enables automatic triggering of RB allocation strategy updates based on factors such as preset time periods, network load changes, and base station status, ensuring system always maintains optimal state.
Global optimization: RIC can formulate optimal resource allocation strategies from a global perspective by collecting network status information from multiple base stations, avoiding local optimization problems that might arise from single base station decisions.
Easy deployment: The present disclosure utilizes O-RAN architecture, communicating with existing network equipment through standard interfaces without changing RAN and core network operation behavior, greatly reducing deployment cost and complexity.
Improved network performance: Experimental results show that the present disclosure can significantly improve throughput of interfered UEs, having important significance for improving 5G network performance.

In summary, the Radio Access Network Intelligent Controller (RAN Intelligent Controller, RIC), dynamic Resource Block configuration method and base station with dynamic Resource Block configuration provided by one or more embodiments of the present disclosure can effectively solve interference problems and low spectrum utilization problems existing in current technology. Through RIC obtaining network status information corresponding to multiple User Equipment (UE) from multiple base stations (BS), identifying interfered UEs, and setting dynamic Resource Block (RB) allocation strategies to divide each BS's allocatable RBs into multiple first RB groups and one second RB group. Among them, first RB group is used for interfered UEs, second RB group is used for other UEs. RIC transmits these strategies to corresponding BSs and can update strategies based on dynamic adjustment conditions. This method not only effectively reduces interference and improves spectrum utilization, but also has high flexibility and scalability, able to adjust resource allocation in real-time according to changes in network environment. Therefore, the present disclosure provides an innovative and efficient solution for 5G network resource management.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A Radio Access Network (RAN) Intelligent Controller (RIC), adapted for a wireless communication system, the RIC comprising:
a communication circuit unit, wherein the RIC is communicatively connected to a plurality of Base Stations (BSs) of the wireless communication system through the communication circuit unit, wherein the plurality of BSs are communicatively connected to a plurality of UEs; and
a processor, wherein the processor is configured by executing a plurality of program modules to:
obtain a plurality of network status information corresponding to the plurality of UEs from the plurality of BSs;
identify at least one first UE being interfered among the plurality of UEs based on the plurality of network status information;
set a plurality of dynamic Resource Block (RB) allocation strategies corresponding to the plurality of BSs based on the plurality of network status information, the at least one first UE, and at least one first BS, so as to divide a plurality of RBs that can be allocated by each BS into a plurality of first RB groups and a second RB group, wherein the plurality of dynamic RB allocation strategies indicate that: a plurality of first RBs in the plurality of first RB groups is used to provide for the at least one first UE, and a plurality of second RBs in the second RB group is used to provide for a second UE other than the at least one first UE among the plurality of UEs;
transmit the plurality of dynamic RB allocation strategies to corresponding ones of the plurality of BSs; and
in response to a dynamic adjustment condition being triggered, re-obtain the network status information to update the plurality of dynamic RB allocation strategies, and transmit the plurality of updated dynamic RB allocation strategies to corresponding ones of the plurality of BSs.

2. The RIC according to claim 1, wherein the network status information comprises:
a plurality of Reference Signal Received Power (RSRP) values of a plurality of transmission pairs between each UE and the plurality of BSs respectively;
a plurality of Reference Signal Received Quality (RSRQ) values of a plurality of transmission pairs between each UE and the plurality of BSs respectively; or
a plurality of Signal-to-Interference-plus-Noise Ratio (SINR) values of a plurality of transmission pairs between each UE and the plurality of BSs respectively.

3. The RIC according to claim 2, wherein identifying the at least one first UE comprises:
calculating RSRP differences between the plurality of transmission pairs of each UE according to the plurality of RSRP values of the plurality of transmission pairs of each UE;
in response to determining that at least one RSRP difference of a UE is less than a preset RSRP threshold value, identifying the UE as one of the at least one first UE.

4. The RIC according to claim 1, wherein setting the plurality of dynamic RB allocation strategies corresponding to the plurality of BSs further comprises:
identifying a plurality of distances between each of the BSs;
identifying a coverage area of each of the BSs;
for one target BS among the plurality of BSs,
identifying at least one neighboring BS according to the plurality of distances and the coverage areas of the plurality of BSs, wherein the coverage area of the at least one neighboring BS partially overlaps with the coverage area of the target BS;
determining a number of the plurality of first RB groups according to a number of the at least one neighboring BS and overlapping relationships between the at least one neighboring BS;
determining a first number of the plurality of first RBs in the plurality of first RB groups and a second number of the plurality of second RBs in the second RB group according to the number of the plurality of first RB groups and a number of the second RB group, wherein the plurality of first RBs is evenly divided into the plurality of first RB groups based on the number of the plurality of first RB groups; and
setting and generating the plurality of dynamic RB allocation strategies to set the plurality of first RB groups and the second RB group to the target BS and the at least one neighboring BS respectively, wherein a target first RB group being set to the target BS among the plurality of first RB groups is different from neighboring first RB groups being set to each neighboring BS among the plurality of first RB groups, and the neighboring first RB groups of two BSs that are not neighboring to each other among the at least one neighboring BS are identical, wherein the second RB group being set to the target BS and the at least one neighboring BS is identical.

5. The RIC according to claim 4, wherein setting and generating the plurality of dynamic RB allocation strategies comprises:
allocating at least one target UE corresponding to the target BS to the target first RB group or the second RB group being set based on whether the at least one target UE corresponding to the target BS is interfered; and
allocating at least one neighboring UE corresponding to each neighboring BS to the neighboring first RB group or the second RB group being set based on whether the at least one neighboring UE of each neighboring BS is interfered.

6. The RIC according to claim 5, the RIC being further configured to:
transmit a target dynamic RB allocation strategy corresponding to the target BS among the plurality of dynamic RB allocation strategies to the target BS, wherein the target dynamic RB allocation strategy is to:
indicate allocatable RBs of the target BS are adjusted from the plurality of RBs to the target first RB group and the second RB group;
indicate that at least one target UE corresponding to the target BS is allocated to the target first RB group or the second RB group respectively; and
transmit neighboring dynamic RB allocation strategies corresponding to each neighboring BS among the plurality of dynamic RB allocation strategies to the neighboring BS, wherein the neighboring dynamic RB allocation strategies are to:
indicate allocatable RBs of the neighboring BS are adjusted from the plurality of RBs to the neighboring first RB group and the second RB group; and
indicate that at least one neighboring UE corresponding to the neighboring BS is allocated to the neighboring first RB group or the second RB group respectively.

7. The RIC according to claim 6, wherein after the target BS receives the target dynamic RB allocation strategy,
the target BS identifies the target first RB group being set to the target BS among the plurality of first RB groups and at least one target first UE being allocated to the target first RB group among the at least one target UE according to the target dynamic RB allocation strategy;
the target BS identifies the second RB group and at least one target second UE being allocated to the second RB group among the at least one target UE according to the target dynamic RB allocation strategy;
the target BS allocates a plurality of target first RBs in the target first RB group to the at least one target first UE according to the target dynamic RB allocation strategy, so as to make at least one target first RB being allocated to each of the at least one target first UE different; and
the target BS allocates the plurality of second RBs in the second RB group to the at least one target second UE according to the target dynamic RB allocation strategy, so as to make at least one second RB being allocated to each of the at least one target second UE different.

8. The RIC according to claim 1, wherein the dynamic adjustment condition comprises: determining that a preset time period is reached; determining that a network load change exceeds a preset threshold; receiving an abnormal status report from at least one BS; receiving an RB allocation strategy update request from at least one BS; detecting that a new BS joins or an existing BS goes offline; or detecting that a network topology corresponding to the wireless communication system changes.

9. A dynamic Resource Block configuration method, adapted for a Radio Access Network (RAN) Intelligent Controller (RIC) of a wireless communication system, wherein the RIC is communicatively connected to a plurality of Base Stations (BSs) of the wireless communication system, wherein the plurality of BSs are communicatively connected to a plurality of UEs, the method comprising:
obtaining a plurality of network status information corresponding to the plurality of UEs from the plurality of BSs;
identifying at least one first UE being interfered among the plurality of UEs based on the plurality of network status information;
setting a plurality of dynamic Resource Block (RB) allocation strategies corresponding to the plurality of BSs based on the plurality of network status information, the at least one first UE, and at least one first BS, so as to divide a plurality of RBs that can be allocated by each BS into a plurality of first RB groups and a second RB group, wherein the plurality of dynamic RB allocation strategies indicate that: a plurality of first RBs in the plurality of first RB groups is used to provide for the at least one first UE, and a plurality of second RBs in the second RB group is used to provide for a second UE other than the at least one first UE among the plurality of UEs;
transmitting the plurality of dynamic RB allocation strategies to corresponding ones of the plurality of BSs; and
in response to a dynamic adjustment condition being triggered, re-obtaining the network status information to update the plurality of dynamic RB allocation strategies, and transmitting the plurality of updated dynamic RB allocation strategies to corresponding ones of the plurality of BSs.

10. The dynamic Resource Block configuration method according to claim 9, wherein the network status information comprises:
a plurality of Reference Signal Received Power (RSRP) values of a plurality of transmission pairs between each UE and the plurality of BSs respectively;
a plurality of Reference Signal Received Quality (RSRQ) values of a plurality of transmission pairs between each UE and the plurality of BSs respectively; or
a plurality of Signal-to-Interference-plus-Noise Ratio (SINR) values of a plurality of transmission pairs between each UE and the plurality of BSs respectively.

11. The dynamic Resource Block configuration method according to claim 10, wherein identifying the at least one first UE comprises:
calculating RSRP differences between the plurality of transmission pairs of each UE according to the plurality of RSRP values of the plurality of transmission pairs of each UE; and
in response to determining that at least one RSRP difference of a UE is less than a preset RSRP threshold value, identifying the UE as one of the at least one first UE.

12. The dynamic Resource Block configuration method according to claim 9, wherein setting the plurality of dynamic RB allocation strategies corresponding to the plurality of BSs further comprises:
identifying a plurality of distances between each of the BSs;
identifying coverage areas of each of the BSs;
identifying at least one neighboring BS for one target BS among the plurality of BSs according to the plurality of distances and the coverage areas of the plurality of BSs, wherein the coverage area of the at least one neighboring BS partially overlaps with the coverage area of the target BS;
determining a number of the plurality of first RB groups according to a number of the at least one neighboring BS and overlapping relationships between the at least one neighboring BS;
determining a first number of the plurality of first RBs in the plurality of first RB groups and a second number of the plurality of second RBs in the second RB group according to the number of the plurality of first RB groups and a number of the second RB group, wherein the plurality of first RBs is evenly divided into the plurality of first RB groups based on the number of the plurality of first RB groups; and
setting and generating the plurality of dynamic RB allocation strategies to set the plurality of first RB groups and the second RB group to the target BS and the at least one neighboring BS respectively, wherein a target first RB group being set to the target BS among the plurality of first RB groups is different from neighboring first RB groups being set to each neighboring BS among the plurality of first RB groups, and the neighboring first RB groups of two BSs that are not neighboring to each other among the at least one neighboring BS are identical, wherein the second RB group being set to the target BS and the at least one neighboring BS is identical.

13. The dynamic Resource Block configuration method according to claim 12, wherein setting and generating the plurality of dynamic RB allocation strategies comprises:
allocating at least one target UE corresponding to the target BS to the target first RB group or the second RB group being set based on whether the at least one target UE corresponding to the target BS is interfered; and
allocating at least one neighboring UE corresponding to each neighboring BS to the neighboring first RB group or the second RB group being set based on whether the at least one neighboring UE of each neighboring BS is interfered.

14. The dynamic Resource Block configuration method according to claim 13, the method further comprising:
transmitting a target dynamic RB allocation strategy corresponding to the target BS among the plurality of dynamic RB allocation strategies to the target BS, wherein the target dynamic RB allocation strategy is to:
indicate allocatable RBs of the target BS are adjusted from the plurality of RBs to the target first RB group and the second RB group;
indicate that at least one target UE corresponding to the target BS is allocated to the target first RB group or the second RB group respectively; and
transmitting neighboring dynamic RB allocation strategies corresponding to each neighboring BS among the plurality of dynamic RB allocation strategies to the neighboring BS, wherein the neighboring dynamic RB allocation strategies are to:
indicate allocatable RBs of the neighboring BS are adjusted from the plurality of RBs to the neighboring first RB group and the second RB group; and
indicate that at least one neighboring UE corresponding to the neighboring BS is allocated to the neighboring first RB group or the second RB group respectively.

15. The dynamic Resource Block configuration method according to claim 9, wherein the dynamic adjustment condition comprises: determining that a preset time period is reached; determining that a network load change exceeds a preset threshold; receiving an abnormal status report from at least one BS; receiving an RB allocation strategy update request from at least one BS; detecting that a new BS joins or an existing BS goes offline; or detecting that a network topology corresponding to the wireless communication system changes.

16. A Base Station with dynamic Resource Block configuration, adapted for a wireless communication system, the Base Station comprising:
a communication circuit unit, wherein the Base Station is communicatively connected to a Radio Access Network (RAN) Intelligent Controller (RIC) of the wireless communication system through the communication circuit unit, wherein the Base Station is communicatively connected to a plurality of UEs through the communication circuit unit; and
a processor, wherein the processor is configured by executing a plurality of program modules to:
continuously receive a plurality of network status information from associated ones of the plurality of UEs, and transmit the received plurality of network status information to the RIC;
in response to receiving a dynamic Resource Block (RB) allocation strategy from the RIC, divide a plurality of RBs that can be allocated by the Base Station into a plurality of first RB groups and a second RB group according to the dynamic RB allocation strategy, and identify a target first RB group being set to the Base Station among the plurality of first RB groups;
identify at least one first UE being allocated to the target first RB group and at least one second UE being allocated to the second RB group among the plurality of UEs according to the dynamic RB allocation strategy;
generate transmission resource allocation information corresponding to the plurality of UEs according to the target first RB group and the second RB group; and
transmit the transmission resource allocation information to the plurality of UEs to enable the plurality of UEs to identify respective allocated RBs according to the received transmission resource allocation information and perform uplink or downlink transmission through the allocated RBs.

17. The Base Station with dynamic Resource Block configuration according to claim 16, wherein
the processor allocates a plurality of target first RBs in the target first RB group to the at least one first UE according to the dynamic RB allocation strategy, so as to make at least one target first RB being allocated to each of the at least one first UE different,
the processor allocates the plurality of second RBs in the second RB group to the at least one second UE according to the dynamic RB allocation strategy, so as to make at least one second RB being allocated to each of the at least one second UE different.

18. The Base Station with dynamic Resource Block configuration according to claim 16, wherein the network status information comprises:
a plurality of Reference Signal Received Power (RSRP) values of a plurality of transmission pairs between each UE and the Base Station respectively;
a plurality of Reference Signal Received Quality (RSRQ) values of a plurality of transmission pairs between each UE and the plurality of Base Stations respectively; or
a plurality of Signal-to-Interference-plus-Noise Ratio (SINR) values of a plurality of transmission pairs between each UE and the plurality of Base Stations respectively.
